(19) United States
(12) Patent Application Publication
(10) Pub. No.: US 2025/0371199 A1
(43) Pub. Date: Dec. 4, 2025

(54) SYSTEM AND METHOD FOR ENHANCING SECURITY OF SYSTEM-ON-CHIP

(71) Applicant: TOYOTA JIDOSHA KABUSHIKI KAISHA, Toyota-shi (JP)

(72) Inventor: Caleb MCGARY, Tokyo (JP)

(73) Assignee: TOYOTA JIDOSHA KABUSHIKI KAISHA, Toyota-shi (JP)

(21) Appl. No.: 18/731,802

(22) Filed: Jun. 3, 2024

(51) Int. Cl. G06F 21/78

(52) U.S. Cl. CPC G06F 21/78

(57) ABSTRACT

Example embodiments of the present disclosure provide enhancement on the security of a system-on-chip (SoC). According to embodiments, a method for enhancing the security of the SoC is provided. The method may be performed by at least one microcontroller unit (MCU) implemented in the SoC and may include: accessing a storage component that stores a plurality of configuration files; selecting at least one configuration file from among the plurality of configuration files; moving the at least one configuration file into a portion of a memory component; and marking the portion of the memory component as non-accessible by other components.

### TECHNICAL FIELD

Example embodiments of the present disclosure relate to system-on-chip (SoC), and more particularly, relate to the enhancement of security of one or more configuration files associated with one or more components in the SoC.

### BACKGROUND

A system-on-chip (SoC) is an integrated circuit that integrates multiple system components into a single chip. The SoC typically includes hardware and software necessary for controlling the operations and functionalities of the hardware. The hardware of the SoC may include a processing system (constituted by a microcontroller unit (MCU) and a plurality of processor cores like a real-time core (R-Core) and an application core (A-Core), etc.) and a storage system. On the other hand, the software of the SoC may include one or more operating systems (OSs) stored in the storage system and loaded by the processing system in operation.

Generally, when the SoC is powered up or reset, a portion of the components of the SoC may be booted before the SoC can fully function. For instance, the MCU and the R-Core may boot at the same time, followed by the booting of the A-Core. An example booting process of the SoC is as follows: the MCU and R-Core (or the operating system associated therewith) may be simultaneously booted, followed by the loading of trusted execution environment (TEE) on the A-Core, the loading of hypervisor(s) associated with the A-Core, and the loading of operating system(s) associated with the A-Core. In this regard, the TEE may host and control the configuration file(s) or parameter(s) associated with the A-Core in a secure manner. For instance, an operating system of the A-Core may load off one or more specific configurations and store the same in the TEE. In this way, the configuration file(s) or parameter(s) associated with the A-Core may be guaranteed to be tamper-proof at runtime from attackers as said configuration file(s) or parameter(s) do not exist in normal memory during runtime.

On the other hand, the configurations of the MCU and R-Core are loaded from one or more configuration files pre-stored in the storage system during the booting of the MCU and the R-Core and stored in a memory component (e.g., flash memory, etc.) during runtime. The one or more configuration files may define various system configurations which are closely related to the security of the SoC, such as the firewall configuration of the SoC. For instance, assuming that the SoC is implemented in a vehicle, the one or more configuration files may define where in the vehicle the Controller Area Network (CAN) messages can be transmitted and to what entities.

Thus, in view of the above, the SoC includes various safety-relevant components (e.g., the MCU, the R-Core, etc.) that are required to be booted prior to the loading of the TEE. Nevertheless, as described in the following, the SoC in the related art possesses a risk of being attacked due to the lack of a mechanism to secure the configuration files of the safety-relevant components during runtime. Further, the SoC in the related art also lacks a mechanism to validate or detect a change in said configuration files, as well as to efficiently restore or recover said configuration files when required.

Specifically, since the safety-relevant components (e.g., the MCU, the R-Core, etc.) are booted prior to the loading of the A-Core, the TEE cannot be utilized to serve or store the associated configurations files since the A-Core has not yet loaded and the TEE has not yet loaded on the A-Core. Further, since said configuration files are typically being stored in an unprotected memory component during runtime, said configuration files may be vulnerable to attackers. Specifically, since there is a time difference between the boot time of the safety-relevant components (e.g., the MCU, the R-Core, etc.) and the boot time of the A-Core, the time gap (even a few seconds) between the boot times may enable an attacker to access and modify the associated configuration files before the booting of the A-Core and the loading of the TEE. Similarly, the attacker may also modify the configuration files at runtime (e.g., when the MCU and/or the R-Core are functioning).

Furthermore, in the related art, the changes in the configuration files of the safety-relevant components (e.g., the MCU, the R-Core, etc.) are unable to be detected or validated. As a result, the SoC of the related art is unable to quickly identify a modification of the configuration files and timely detect or respond to an attack. In addition, the SoC in the related art also lacks a mechanism to automatically recover the configuration files when required.

### SUMMARY

Example embodiments consistent with the present disclosure effectively and efficiently provide enhancement on the security of an SoC.

According to example embodiments, a method for enhancing the security of the SoC is provided. The method may be performed by at least one microcontroller unit (MCU) implemented in the SoC and may include: accessing a storage component that stores a plurality of configuration files; selecting at least one configuration file from among the plurality of configuration files; moving the at least one configuration file into a portion of a memory component; and marking the portion of the memory component as non-accessible by other components.

According to example embodiments, an SoC is provided. The SoC may include a memory component storing computer-readable instructions and an MCU communicatively coupled to the memory component. The MCU may be configured to execute the instructions to: access a storage component that stores a plurality of configuration files; select at least one configuration file from among the plurality of configuration files; move the at least one configuration file into a portion of a memory component; and mark the portion of the memory component as non-accessible by other components.

According to example embodiments, a non-transitory computer-readable recording medium is provided. The non-transitory computer-readable recording medium may have recorded thereon instructions executable by at least one MCU implemented in an SoC to cause the MCU to perform a method to enhance the security of the SoC. The method may include: accessing a storage component that stores a plurality of configuration files; selecting at least one configuration file from among the plurality of configuration files; moving the at least one configuration file into a portion of a memory component; and marking the portion of the memory component as non-accessible by other components.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a block diagram of example components of a system on chip (SoC), according to one or more example embodiments;

FIG. 2 illustrates a block diagram of an example communication configuration for enhancing the security of a configuration file of an MCU, according to one or more example embodiments;

FIG. 3 illustrates a flow diagram of an example method for enhancing the security of a configuration file of an MCU, according to one or more example embodiments;

FIG. 4 illustrates a block diagram of an example communication configuration for enhancing the security of a configuration file of an R-Core, according to one or more example embodiments;

FIG. 5 illustrates a block diagram of an example communication configuration for managing a configuration file, according to one or more example embodiments; and

FIG. 6 illustrates a flow diagram of an example method for managing a configuration file, according to one or more example embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Furthermore, the term “vehicle” described herein refers to any suitable type of vehicle in which example embodiments of the present disclosure can be implemented. For instance, the “vehicle” may refer to a motorized vehicle such as a car, a truck, a bus, a motorcycle, or any other suitable type of automobile powered by an engine, motor, or other mechanical means. Alternatively or additionally, the “vehicle” described herein may refer to a bicycle, a skateboard, and any other suitable types of non-motorized vehicle, without departing from the scope of the present disclosure.

Example embodiments of the present disclosure provide methods, systems, and devices for enhancing the security of a system-on-chip (SoC). Specifically, example embodiments of the present disclosure securely manage the configuration files of one or more safety-related components, such as the microcontroller unit (MCU) and the real-time core (R-Core), throughout different stages or processes of the SoC, thereby reducing the risk of the configuration files being compromised or tampered with. Further, example embodiments of the present disclosure detect and validate changes in the configuration files and timely restore the configuration files as per requirement. Ultimately, example embodiments of the present disclosure effectively and efficiently enhanced the security of the components of the SoC.

It is contemplated that features, advantages, and significances of example embodiments described herein are merely a portion of the present disclosure, and are not intended to be exhaustive or to limit the scope of the present disclosure. Further descriptions of the features, components, configuration, operations, and implementations of the example embodiments of the present disclosure are provided in the following.

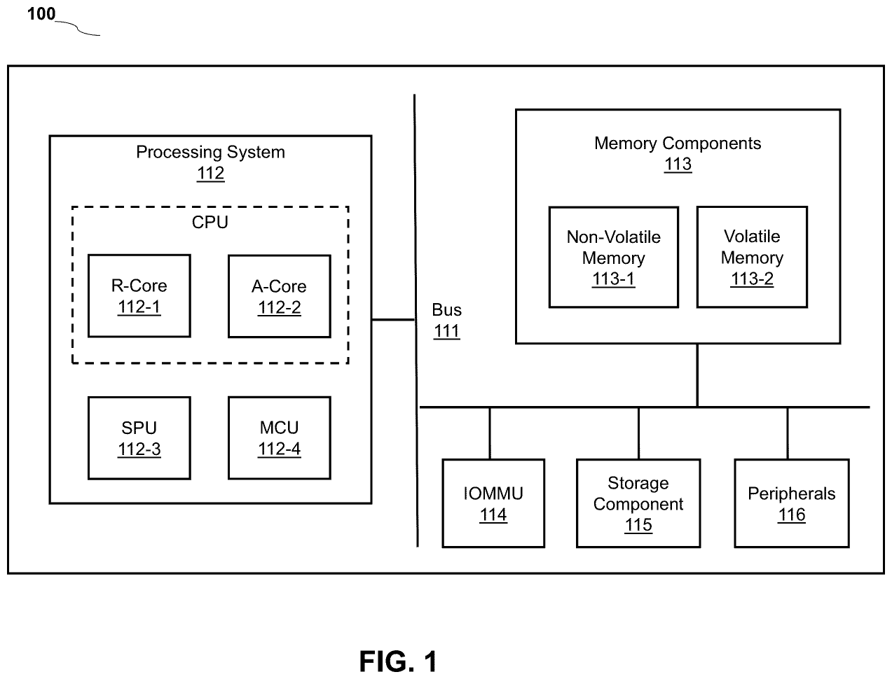

FIG. 1 illustrates a block diagram of example components of a system on chip (SoC) 100, according to one or more example embodiments. As illustrated in FIG. 1, the SoC 100 may include at least one bus 111, at least one processing system 112, a plurality of memory components 113, at least one input/output memory management unit (IOMMU) 114, at least one storage component 115, and a plurality of peripherals 116. One or more of the components 111-116 may be implemented in hardware, firmware, or a combination of hardware and software. It is contemplated that the components of the SoC 100 are simplified for descriptive purposes, and the SoC 100 may include additional components and/or may be configured in a different matter according to implementations, without departing from the scope of the present disclosure. For instance, in some implementations, the storage component 115 may be implemented as a part of the memory system 113, the processing system 112 may include more than one R-Core and more than one A-Core, and the like.

The at least one bus 111 may be configured to facilitate or enable communications among the components of the SoC 100. Specifically, the bus 111 may communicatively couple the components to each other and provide a means for data transfer and flow of control signals between the components. The bus 111 may include various types of communication bus, such as an address bus, a data bus, a control bus, a memory bus, a peripheral bus, and any other suitable type of bus that can be implemented in the SoC 100 to enable communication and coordination between the components within the SoC 100. Further, the bus 111 may include a parallel bus that facilitates parallel communication or data access among the components of the SoC 100, a serial bus that facilitates serial communication of data access among the components of the SoC 100, or a combination thereof. Furthermore, the bus width of the bus 111 may be 8 bits, 16 bits, 32 bits, 128 bits, or a higher bus width.

The processing system 112 may be capable of being programmed or configured to perform one or more operations described herein. As illustrated in FIG. 1, the processing system 112 may include at least one real-time core (R-Core) 112-1, at least one application core (A-Core) 112-2, at least one secure processing unit (SPU) 112-3, and at least one microcontroller unit (MCU) 112-4. It is contemplated that the processing system 112 may include more/less components and/or may be configured in a different manner, without departing from the scope of the present disclosure. For instance, the SPU 112-3 and the MCU 112-4 may be implemented separately from the processing system 112, the processing system 112 may further include a microprocessor and a digital signal processor (DSP), and the like.

According to example embodiments, the R-Core 112-1 and the A-Core 112-2 may constitute a central processing unit (CPU). The R-Core 112-1 may be configured to perform real-time operations and manage tasks with real-time requirements such as monitoring and controlling safety-related functions, performing automotive-related operations, and the like. Conversely, the A-Core 112-2 may be configured to perform performance-intensive and non-real-time operations (i.e., operations that do not have stringent timing requirements) and manage a wide range of application software for various tasks, such as general-purpose computing, multimedia processing, networking, operational system support, and the like. The R-Core 112-1 and the A-Core 112-2 may be configured to interoperate with each other to achieve a balance between real-time responsiveness and application flexibility.

The SPU 112-3 may include one or more processing units dedicated to handling or performing security-related operations within the SoC 100. According to example embodiments, the SPU 112-3 may be configured to provide hardware-based security features, such as cryptographic operations, providing secure storage, secure memory creations, secure communications, secure processing, and the like. As further described below, in some example embodiments, the SPU 112-3 may be communicatively coupled to a safety island (SAIL) on the R-Core 112-1 (via the bus 111), and the control of the SPU 112-3 may be mapped or provided by the SAIL of the R-Core 112-1.

The MCU 112-4 may include one or more processing units dedicated to handling or performing low-power operations, such as embedded components control (e.g., control of electronic control components (ECUs) in a vehicle system, sensor monitoring, etc.) According to example embodiments, the MCU 112-4 may include one or more integrated circuits that include its own CPU, memory component, peripherals, and the like.

The memory components 113 may include one or more mediums for storing temporary data, runtime variables, bootloaders, computer-readable or program instructions, caches, and buffers required for the operations of the SoC 100. As illustrated in FIG. 1, the memory components 113 may include at least one non-volatile memory 113-1 and at least one volatile memory 113-2.

The non-volatile memory 113-1 refers to a memory storage medium that, when the power goes down, maintains the contents stored in the memory storage medium. The non-volatile memory 113-1 may be configured to store boot codes or computer-readable instructions for booting the components of the SoC 100 (e.g., R-Core 112-1, A-Core 112-2, MCU 112-4, etc.) In some example implementations, the non-volatile memory 113-1 may also be configured to store configuration files associated with the SoC 100. According to example embodiments, the non-volatile memory 113-1 may include one or more of: a flash memory, a read-only memory (ROM), a programmable ROM (PROM), an erasable PROM (EPROM), an electrically EPROM (EEPROM), a ferroelectric RAM (FRAM), a magnetoresistive RAM (MRAM), a phase-change RAM (PRAM), a resistive RAM (ReRAM), a ferroelectric field-effect transistor memory (FeFET), and any other suitable type of non-volatile memory.

The volatile memory 113-2 refers to a memory storage medium that, when the power goes down, resets or erases the contents stored in the memory storage medium. The volatile memory may be configured to store temporary data or information. According to example embodiments, the volatile memory 113-2 may include one or more of: a static random-access memory (RAM), a synchronous RAM (SSRAM), a dynamic RAM (DRAM), a synchronous DRAM (SDRAM), a dual data rate RAM (DDR RAM), a dual data rate SDRAM (DDR SDRAM), a graphical DDR SDRAM (GDDR SDRAM), a low-power DDR SDRAM (LDDR SDRAM), a quad data rate SDRAM (QDR SDRAM), and any other suitable type of volatile memory.

The IOMMU 114 may include one or more components configured to manage memory accesses between the components of the SoC 100 (e.g., the processing system 112, etc.) and the memory components 113. According to example embodiments, the IOMMU 114 may be configured to receive a virtual/logical address from the processing system 112, and then convert or translate (e.g., by utilizing internal address tables, etc.) the virtual/logical address to a physical address for the usage of other components of the SoC 100. Further, the IOMMU 114 may also be configured to provide virtual memories by, for example, delivering more logical address space than the physically available memory space.

According to example embodiments, the IOMMU 114 may be configured to provide protection of different memory areas by, for example, marking a specific portion of the memory components 113 as access/non-accessible by a specific component. As further described below, the IOMMU 114 may be communicatively coupled to the MCU 112-4 (via the bus 111) and may receive an instruction from the MCU 112-4 to mark a specific portion of the memory components 113 as non-accessible and/or accessible by other components of the SoC 100 and other external components.

The storage component 115 may include one or more storage mediums configured to store non-volatile data, such as operating system (OS), firmware, configuration settings, calibration data, information, and/or software related to the operation and use of the SoC 100. According to example implementations, the storage component 115 may include one or more storage mediums embedded in the SoC 100, such as an embedded flash memory, an embedded multimedia card (eMMC), and the like. Additionally or alternatively, the storage component 115 may include one or more external storage mediums communicatively coupled to the SoC 100, such as a detachable secure digital (SD) card, a detachable MMC, and the like. It is contemplated that the storage component 115 may include any other suitable types of non-transitory computer-readable medium, without departing from the scope of the present disclosure.

According to example embodiments, the storage component 115 may be configured to store computer-readable or computer-executable instructions for implementing one or more operations described herein, one or more configuration files associated with one or more components of the SoC 100, historical information of one or more operations performed by the SoC 100 (or one or more components thereof), and the like.

The peripherals 116 may include one or more components that interoperate with other components of the SoC 100 to enhance the efficiency and effectiveness of the SoC 100. According to example embodiments, the peripherals 116 may include one or more communication interfaces, such as a transceiver-like component (e.g., a transceiver and/or a separate receiver and transmitter) that enables the SoC 100 (or the components thereof) to communicate with one or more external components, such as via a wired connection, a wireless connection, or a combination of wired and wireless connections. For example, peripherals 116 may include one or more of: a universal asynchronous receiver/transmitter (UART), a controller area network (CAN) bus interface, an Ethernet interface, a serial peripheral interface (SPI), an optical interface, a coaxial interface, an infrared interface, a radio frequency (RF) interface, a universal serial bus (USB) interface, a high-definition multimedia interface (HDMI), a Wi-Fi interface, a cellular network interface, one or more application programming interfaces (APIs), and the like.

According to example embodiments, the peripherals 116 may include a pulse-width modulator (PWM), an analog-to-digital converter (ADC), a digital-to-analog converter (DAC), a timer/counter, an inter-integrated circuit (I2C), a general-purpose input/output (GIPOs), a fixed analog component, a programmable analog component, a fixed digital component, a programmable digital component, and the like.

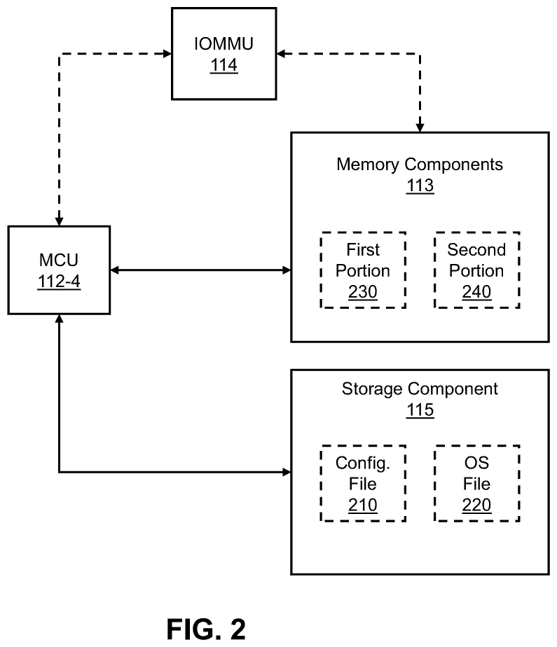

The safety-related components (e.g., MCU 112-4, R-Core 112-1, etc.) of the SoC 100 may be configured to interoperate with other components (e.g., SPU 112-3, A-Core 112-2, IOMMU 114, etc.) of the SoC 100, thereby providing enhancement on the security of the SoC 100. Example embodiments associated therewith are further described in the following with reference to FIG. 2 to FIG. 6.

FIG. 2 illustrates a block diagram of an example communication configuration for enhancing the security of a configuration file of an MCU, according to one or more example embodiments. In this example, the MCU 112-4, the memory components 113, the IOMMU 114, and the storage component 115 in the SoC 100 of FIG. 1 are involved and the communication therebetween may be performed via the bus 111 of the SoC 100. It can be understood that more or less components of the SoC 100 may be involved, without departing from the scope of the present disclosure.

As illustrated in FIG. 2, the storage component 115 may be configured to store one or more configuration files 210 and one or more operating system (OS) files 220. The one or more configuration files 210 may include configuration information (e.g., OS configuration, firewall configuration, peripheral configuration, power management configuration, system configuration, communication protocol configuration, etc.) associated with one or more components of the SoC 100, such as configuration file(s) associated with the MCU 112-4, the R-Core 112-1, the A-Core 112-2, and the like.

Further, the one or more OS files 220 may include programming codes or image files of one or more OS associated with one or more components of the SoC 100, such as OS associated with the MCU 112-4, OS associated with the R-Core 112-1, OS associated with the A-Core 112-2, and the like. According to example embodiments, the OS associated with the MCU 112-4 and the R-Core 112-1 may include one or more real-time OS (RTOS), while the OS associated with the A-Core 112-2 may include one or more rich OS and/or one or more general-purpose OS.

Merely for descriptive purposes, it may be assumed that the OS file in FIG. 2 is associated with an OS of the MCU 112-4, and the configuration file in FIG. 2 is associated with the OS of the MCU 112-4. In this regard, the configuration file may include information associated with the OS configuration, such as the OS kernel configuration, initial RAM disk (initrd) configuration, device tree blob (DTB) configuration, bootloader configuration, and the like.

Referring still to FIG. 2, the memory components 113 may include a first portion 230 and a second portion 240. In this regard, the “portion” described herein may refer to the non-volatile memory 113-1 or the volatile memory 113-2, as well as may refer to a partition in the non-volatile memory 113-1 or a partition in the volatile memory 113-2. Further, it is contemplated that the memory components 113 may include more than two portions, without departing from the scope of the present disclosure.

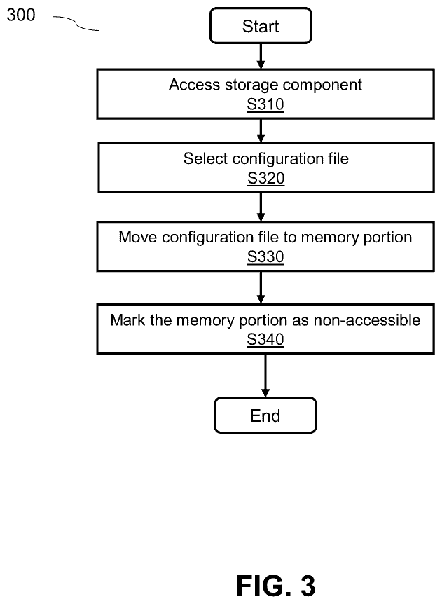

Example operations performable by the MCU 112-4 in the example configuration of FIG. 2 are described in the following. FIG. 3 illustrates a flow diagram of an example method 300 for enhancing the security of a configuration file of an MCU, according to one or more example embodiments. One or more operations of the method 300 may be performed by the MCU 112-4, during the boot process of the MCU 112-4. For instance, said one or more operations may be implemented by a bootloader of the MCU 112-4 upon executing a boot firmware stored in a boot ROM (in the memory components 113).

Referring to FIG. 3, at operation S310, the MCU 112-4 may be configured to access a storage component that stores a plurality of configuration files. For instance, in the example of FIG. 2, the MCU 112-4 may access (via the bus 111) the storage component 115 that stores a plurality of configuration files 210.

Subsequently, at operation S320, the MCU 112-4 may be configured to select at least one configuration file from among the plurality of configuration files. For instance, the MCU 112-4 may determine the configuration files associated with the MCU 112-4, and then select the configuration file(s) associated with the OS of the MCU 112-4 therefrom.

Next, at operation S330, the MCU 112-4 may be configured to move the selected configuration file(s) from the storage component to a portion of a memory component. For instance, in the example of FIG. 2, the MCU 112-4 may move the configuration file 210 to the first portion 230 (or the second portion 240) of the memory components 113.

Accordingly, at operation S340, the MCU 112-4 may be configured to mark the portion of the memory components 130 (in which the configuration file(s) are temporarily stored) as non-accessible by other components of the SoC and/or one or more external components. For instance, the marked portion of the memory components will not be accessible by any components with a running OS, by any unauthenticated or unauthorized components external from the SoC, and the like. In some implementations, instead of marking the portion of the memory components as non-accessible, the MCU 112-4 may mark the portion of the memory component as non-writable.

According to example embodiments, the MCU 112-4 may employ memory protection mechanisms, such as assigning specific memory attributes and access permissions to the portion of the memory component, managing or enforcing access control policies, managing or enforcing access control lists (ACLs) or permissions tables, and the like, to mark the portion of the memory component as accessible or non-accessible.

According to example embodiments, the MCU 112-4 may be configured to interoperate with the IOMMU 114 to mark the portion of the memory components 113 as non-accessible. In this case, at operation S340, the MCU 112-4 may generate an instruction to mark the portion of the memory component as non-accessible, and then provide the instruction to the IOMMU 114. Accordingly, the IOMMU 114 may be configured to mark the portion of the memory component as non-accessible.

Upon marking the memory as non-accessible, the MCU 112-4 may be configured to prepare and launch one or more OS. For instance, the MCU 112-4 may access the marked portion of the memory component to read the at least one configuration file, and then initialize an environment (e.g., software environment, hardware environment, etc.) for loading the OS associated with the at least one configuration file. Accordingly, the MCU 112-4 may load the OS in the initialized environment and then launch the OS therein. The OS may include an RTOS, a rich OS, and any other suitable types of OS.

Further, after marking the portion of the memory as non-accessible, the MCU 112-4 may initiate the loading of a trusted execution environment (TEE) in an A-Core (e.g., A-Core 112-2). For instance, the MCU 112-4 may send at least one signal or message to the A-Core, thereby triggering the A-Core to load the TEE therein. As another example, the MCU 112-4 may write a status flag or variable into the memory components 113 and/or the storage component 115, such that the A-Core can periodically (or continuously) check the memory components 113 and/or the storage component 115 to determine the status of the MCU 112-4 and then load the TEE based thereon. In addition, the MCU 112-4 may send at least one signal or message to a power management unit (PMU), such that the PMU may supply the power to activate the A-Core thereafter.

Furthermore, the MCU 112-4 may remove or retrieve the configuration file(s) from the portion of the memory components during the shutdown process of the SoC. Specifically, upon marking the portion of the memory components as non-accessible (or non-writable), the MCU 112-4 may continuously (or periodically) determine whether or not the SoC is entering a shutdown process. In this regard, based on determining that the SoC is entering the shutdown process, the MCU 112-4 may remove the at least one configuration file from the portion of the memory components and then mark the portion of the memory components as accessible by other components of the SoC, in a similar manner as to how the MCU 112-4 mark said portion as non-accessible. For instance, the MCU 112-4 may generate an instruction to mark the portion of the memory components as accessible and then provide the instruction to the IOMMU 114, such that the IOMMU 114 can be configured to mark the portion of the memory components as accessible.

In view of the above, example embodiments of the present disclosure provide systems and mechanisms to reserve and mark the portion of the memory components as non-accessible/non-writable post boot. In this way, the configuration file(s) can be stored in the secured memory portion during the runtime of the MCU 112-4, and be retrieved therefrom in the shutdown process. Accordingly, the runtime compromise or tampering of the configuration file(s) can be effectively and efficiently prevented.

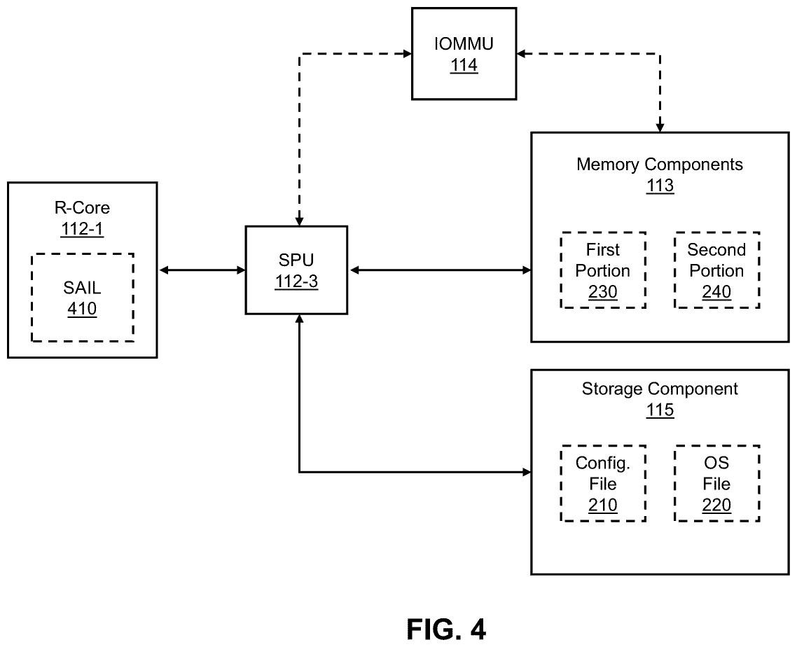

Next, example embodiments associated with the R-Core are described. FIG. 4 illustrates a block diagram of an example communication configuration for enhancing the security of a configuration file of an R-Core, according to one or more example embodiments. In this example, the R-Core 112-1, the SPU 112-3, the memory components 113, the IOMMU 114, and the storage component 115 in the SoC 100 of FIG. 1 are involved and the communication therebetween may be performed via the bus 111 of the SoC 100. It can be understood that more or less components of the SoC 100 may be involved, without departing from the scope of the present disclosure.

A portion of the configuration in FIG. 4 may be similar to the configuration in FIG. 2. For instance, the storage component 115 may have one or more configuration files 210 and one or more OS files 220 stored therein, the memory components 113 may include a first portion 230 and a second portion 240, and the like. The configurations are different in that, the operations involving the configuration file(s) are performed by the MCU 112-4 in FIG. 2, while the operations involving the configuration file(s) are performed by the SPU 112-3 instead of the R-Core 112-1.

Specifically, the operations of the SPU 112-3 are controlled or mapped by the safety island (SAIL) 410 on the R-Core 112-1, and the configuration file(s) associated with the R-Core 112-1 may be managed by the SPU 112-3 under the control of the SAIL 410. For instance, during the boot process of the R-Core 112-1, the SAIL 410 may generate and provide a signal or message to instruct the SPU 112-3 to access the storage component 115, to select at least one configuration file from the storage component 115, to move the selected configuration file(s) to a portion of the memory components 113, to mark the portion of the memory components 113 as non-accessible and accessible, and to initiate the loading of a TEE of the A-Core, in a similar manner as described above with reference to FIG. 2 and FIG. 3.

In view of the above, any operation or action that needs to be taken involving the configuration file(s) of the R-Core 112-1 shall only execute on the SPU 112-3, and the configuration file(s) will not be exposed (e.g., in plain text) on the R-Core 112-1. Accordingly, the risk of the configuration file(s) being compromised or tampered with can be further reduced.

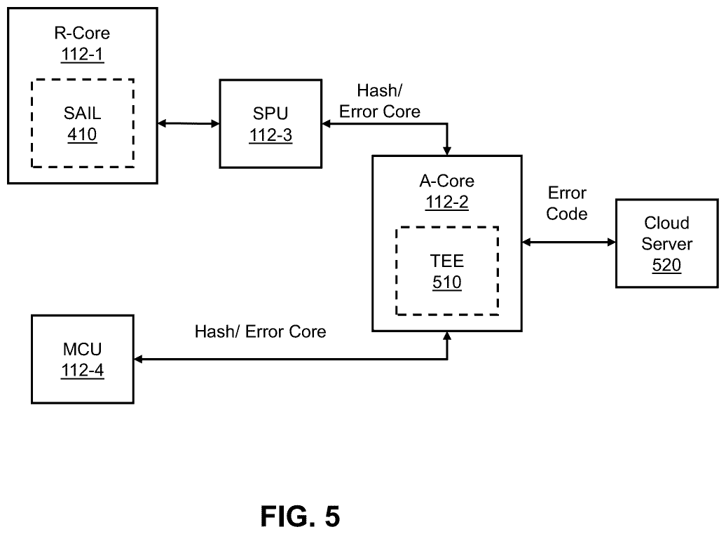

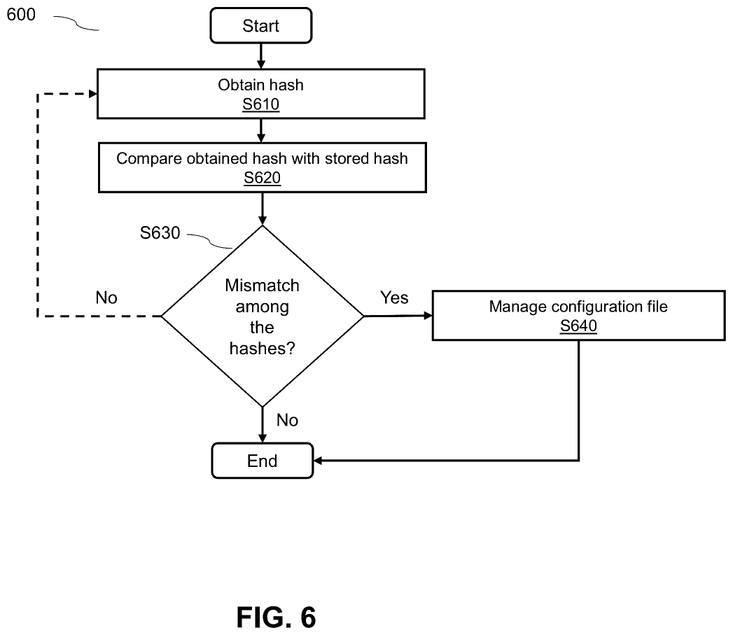

Next, example embodiments associated with the validation and detection of the configuration file(s), as well as the recovery of the configuration file(s), are described with reference to FIG. 5 and FIG. 6.

FIG. 5 illustrates a block diagram of an example communication configuration for managing a configuration file, according to one or more example embodiments. In this example, the R-Core 112-1, the A-Core 112-2, the SPU 112-3, and the MCU 112-4 in the SoC 100 of FIG. 1 are involved and the communication therebetween may be performed via the bus 111 of the SoC 100. It can be understood that more or less components of the SoC 100 may be involved, without departing from the scope of the present disclosure.

In addition to the components of the SoC 100, at least one cloud server 520 may also be involved in the example of the FIG. 5. The cloud server 520 may be associated with a service center that is responsible for handling error codes provided by the components of the SoC. The communication between the cloud server 520 and the components of the SoC 100 (e.g., A-Core 112-2, SPU 112-3, MCU 112-4, etc.) may be performed via the peripherals 116 of the SoC 100.

As illustrated in FIG. 5, the A-Core 112-2 may include or implement a trusted execution environment (TEE) 510. The TEE 510 may include a secure and isolated execution environment in which one or more specific operations, such as secure data processing, management of configuration files, launching of trusted OS, and the like, can be securely performed. According to example embodiments, the TEE 510 may be implemented as a hardware-isolated execution environment within the A-Core 112-2 that provides access control among the content or runtime within the TEE 510 and the components external to the TEE 510.

The loading of the TEE 510 may be automatically initiated when the A-Core 112-2 is first powered up (i.e., when the A-Core 112-2 is powered up by the PMU, etc.) Alternatively, the A-Core 112-2 may load the TEE 510 upon receiving a signal or message from the R-Core 112-1 and/or the MCU 112-4 indicating the completion of the booting of the R-Core 112-1 and/or the MCU 112-4. Further, the A-Core 112-2 may periodically (or continuously) check one or more storage mediums (e.g., a portion of the memory components 113, the storage component 115, etc.) for the information associated with the status of the R-Core 112-1 and/or the MCU 112-4 (e.g., status flag, etc.), and then load the TEE 510 upon determining the completion of the booting of the R-Core 112-1 and/or the MCU 112-4.

According to example embodiments, the TEE 510 may be configured to store a plurality of hashes, each of which is associated with a corresponding configuration file. In this regard, the hash may include a fixed-size string of bytes (e.g., a hexadecimal number, a unique string of characters, etc.) that is generated based on the contents of the associated configuration file. Since any changes in the configuration file will result in changes in the associated hash, whenever the components of the SoC 100 (e.g., the MCU 112-4, the R-Core 112-1, etc.) update or change the associated configuration file(s), the associated hash in the TEE 510 shall also be updated. Thus, the hashes of the configuration files may be utilized for managing (e.g., validating and recovering) the configuration files of the components of the SoC (e.g., the R-Core 112-1, the MCU 112-4, etc.). Example operations associated therewith are described in the following with reference to FIG. 6.

FIG. 6 illustrates a flow diagram of an example method 600 for managing a configuration file, according to one or more example embodiments. One or more operations of the method 600 may be performed or implemented by a TEE of an A-Core. According to example embodiments, the method 600 may be initiated by the TEE during the boot process of an OS (e.g., secure OS, rich OS, etc.) within the TEE.

Referring to FIG. 6, at operation S610, the TEE may be configured to obtain at least one hash from the components of the SoC. For instance, in the example of FIG. 5, the TEE 510 may obtain the hash from the R-Core 112-1 and the MCU 112-4. In this regard, the TEE 510 may communicate with the MCU 112-4 via the bus 111 of the SoC 100, and establish a secure connection to the MCU 112-4 to obtain the hash therefrom. On the other hand, the TEE 510 may communicate with the SAIL 410 of the R-Core 112-1 (via the SPU 112-3) and may request the SAIL 410 (via attestation, etc.) to provide the hash, and the SPU 112-3 may return the requested hash to the TEE 510 accordingly.

Upon obtaining the hash, the method 600 may proceed to operation S620, at which the TEE 510 may be configured to compare the obtained hash with an associated hash stored within the TEE 510. Accordingly, at operation S630, the TEE 510 may determine whether or not there is any mismatch among the hashes. In this regard, based on determining that there is a mismatch between the hashes, the method 600 may proceed to operation S640, at which the TEE 510 may be configured to perform one or more operations to manage the associated configuration file. Otherwise, the method 600 may be terminated or ended, or may return to operation S610 such that the TEE 510 may iteratively perform the method 600 for at least a period of time.

According to example embodiments, at operation S640, the TEE 510 may limit the functionalities that are available to the component(s) associated with the hashes and then provide a message to said component(s) notifying that the component(s) is operating in an error state. Accordingly, TEE 510 may perform one or more operations to recover the associated configuration file(s). An example use case associated therewith is described in the following with reference to FIG. 5.

In the example of FIG. 5, the TEE 510 may detect a mismatch between the hashes of the R-Core 112-1 and a mismatch between the hashes of the MCU 112-4, and then limit the functionalities available to the R-Core 112-1 and the MCU 112-4 while notifying them that they are operating in the error state.

Upon receiving the notification from the TEE 510, the R-Core 112-1 and the MCU 112-4 may perform one or more operations to self-diagnose and reboot when applicable. In this regard, the TEE 510 does not automatically reset the configuration file. Rather, the R-Core 112-1 and the MCU 112-4 shall request a copy of the non-corrupted configuration file when applicable. Specifically, upon performing the self-diagnose, the R-Core 112-1 and the MCU 112-4 may provide, to the TEE 510, an error code and a request for the non-corrupted configuration file, thereby informing the TEE 510 that they have self-detected that they are in a vulnerable state and requesting the non-corrupted configuration file.

Accordingly, the TEE 510 may transmit the error code to the cloud server 520 via, for example, a data communication module (DCM). The DCM may be integrated into the SoC, or may be an external, off-chip component communicatively coupled to the SoC. Subsequently, the cloud server 520 may provide a response (e.g., an acknowledgment message, etc.) to the TEE 510, notifying the TEE 510 that the error code has been safely received. In this regard, if the TEE 510 receives the response from the cloud server 520, the TEE 510 may then provide the full, non-corrupted configuration file to the R-Core 112-1 and the MCU 112-4. Otherwise, if the TEE 510 does not receive the response from the cloud server 520, the TEE 510 may provide a constrained, safe configuration file that is option limited (e.g., bare minimum configuration, etc.) to the R-Core 112-1 and the MCU 112-4, such that only the minimum or essential functionality required for the SoC to operate in a safe manner is provided to the R-Core 112-1 and the MCU 112-4.

In view of the above, since the TEE 510 only provides the non-corrupted configuration upon validation, this can prevent an attacker or other misconfiguration from obtaining the uncorrupted file and the impacts of its actions on the associated components (e.g., MCU 112-4, the R-Core 112-1, etc.) can be effectively reduced.

To this end, example embodiments of the present disclosure effectively and efficiently enhance the security of the SoC. Specifically, as compared to the related art SoC that simply loads and stores the configuration file(s) of the components in unprotected memory during runtime, example embodiments of the present disclosure move the configuration file(s) into a portion of the memory during the boot process and then mark the portion as non-accessible or addressable (e.g., by a running OS, by an unauthenticated component, etc.) to protect the configuration file(s) during runtime. Further, example embodiments of the present disclosure also detect and validate the integrity of the configuration file(s), collect error code(s) prior to restoring the affected configuration file(s), and appropriately restore the configuration file(s) based on thereon (e.g., restoring full configuration file, restoring configuration file minimum required attributes, etc.)

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a SoC, a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method performed by at least one microcontroller unit (MCU) implemented in a system on chip (SoC) to enhance security of the SoC, the method comprising
accessing a storage component that stores a plurality of configuration files;
selecting at least one configuration file from among the plurality of configuration files;
moving the at least one configuration file into a portion of a memory component; and
marking the portion of the memory component as non-accessible by other components.

2. The method according to claim 1, wherein the marking the portion of the memory component as non-accessible comprises:
generating an instruction to mark the portion of the memory component as non-accessible; and
providing the instruction to an input/output memory management unit (IOMMU), wherein the IOMMU is configured to mark the portion of the memory component as non-accessible.

3. The method according to claim 1, further comprising:
determining whether or not the SoC is entering a shutdown process;
based on determining that the SoC is entering the shutdown process, removing the at least one configuration file from the portion of the memory component; and
marking the portion of the memory component as accessible by other components.

4. The method according to claim 3, wherein the marking the portion of the memory component as accessible comprises:
generating an instruction to mark the portion of the memory component as accessible; and
providing the instruction to the IOMMU, wherein the IOMMU is configured to mark the portion of the memory component as accessible.

5. The method according to claim 1, further comprising:
accessing the portion of the memory component to read the at least one configuration file;
initializing, based on the at least one configuration file, an environment for loading an operational system (OS) associated with the configuration file; and
loading the OS in the initialized environment.

6. The method according to claim 1, further comprising:
after marking the portion of the memory component as non-accessible, initiating the loading of a trusted execution environment (TEE) in an application core (A-Core).

7. The method according to claim 1, wherein the method is implemented by a bootloader of the MCU upon executing a boot firmware stored in a boot read-only memory (ROM).

8. A system on chip (SoC) comprising:
a memory component storing computer-readable instructions; and
a microcontroller unit (MCU) communicatively coupled to the memory component, wherein the MCU is configured to execute the instructions to:
access a storage component that stores a plurality of configuration files;
select at least one configuration file from among the plurality of configuration files;
move the at least one configuration file into a portion of a memory component; and
mark the portion of the memory component as non-accessible by other components.

9. The SoC according to claim 8, wherein the MCU is configured to mark the portion of the memory storage as non-accessible by:
generating an instruction to mark the portion of the memory component as non-accessible; and
providing the instruction to an input/output memory management unit (IOMMU), wherein the IOMMU is configured to mark the portion of the memory component as non-accessible.

10. The SoC according to claim 8, wherein the MCU is further configured to execute the instructions to:
determine whether or not the SoC is entering a shutdown process;
based on determining that the SoC is entering the shutdown process, remove the at least one configuration file from the portion of the memory component; and
mark the portion of the storage component as accessible by other components.

11. The SoC according to claim 10, wherein the MCU is configured to mark the portion of the memory component as accessible by:
generating an instruction to mark the portion of the memory component as accessible; and
providing the instruction to the IOMMU, wherein the IOMMU is configured to mark the portion of the memory component as accessible.

12. The SoC according to claim 8, wherein the MCU is further configured to execute the instructions to:
access the portion of the memory component to read the at least one configuration file;
initialize, based on the at least one configuration file, an environment for loading an operational system (OS) associated with the configuration file; and
load the OS in the initialized environment.

13. The SoC according to claim 8, wherein the MCU is further configured to execute the instructions to:
after marking the portion of the memory component as non-accessible, initiate the loading of a trusted execution environment (TEE) in an application core (A-Core).

14. The SoC according to claim 8, wherein the memory component comprises a boot read-only memory (ROM), and wherein the computer-readable instructions comprises instructions for implementing a boot firmware stored in the boot ROM.

15. A non-transitory computer-readable recording medium having recorded thereon instructions executable by at least one microcontroller unit (MCU) implemented in a system on chip (SoC) to cause the MCU to perform a method to enhance security of the SoC, the method comprising:
accessing a storage component that stores a plurality of configuration files;
selecting at least one configuration file from among the plurality of configuration files;
moving the at least one configuration file into a portion of a memory component; and
marking the portion of the memory component as non-accessible by other components.

16. The non-transitory computer-readable recording medium according to claim 15, wherein the marking the portion of the memory component as non-accessible comprises:
generating an instruction to mark the portion of the memory component as non-accessible; and
providing the instruction to an input/output memory management unit (IOMMU), wherein the IOMMU is configured to mark the portion of the memory component as non-accessible.

17. The non-transitory computer-readable recording medium according to claim 15, wherein the method further comprises:
determining whether or not the SoC is entering a shutdown process;
based on determining that the SoC is entering the shutdown process, removing the at least one configuration file from the portion of the memory component; and
marking the portion of the memory component as accessible by other components of the SoC.

18. The non-transitory computer-readable recording medium according to claim 17, wherein the marking the portion of the memory component as accessible comprises:
generating an instruction to mark the portion of the memory component as accessible; and
providing the instruction to the IOMMU, wherein the IOMMU is configured to mark the portion of the memory component as accessible.

19. The non-transitory computer-readable recording medium according to claim 15, wherein the method further comprises:
accessing the portion of the memory component to read the at least one configuration file;
initializing, based on the at least one configuration file, an environment for loading an operational system (OS) associated with the configuration file; and
loading the OS in the initialized environment.

20. The non-transitory computer-readable recording medium according to claim 15, wherein the method further comprises:
after marking the portion of the memory component as non-accessible, initiating the loading of a trusted execution environment (TEE) in an application core (A-Core).
